(19) United States
(12) Patent Application Publication
(10) Pub. No.: US 2018/0191655 A1
(43) Pub. Date: Jul. 5, 2018

(54) VERIFYING ELECTRONIC MESSAGE INTEGRITY

(71) Applicant: CA, Inc., New York, NY (US)

(72) Inventor: Dhiraj Girdhar, Westborough, MA (US)

(21) Appl. No.: 15/397,636

(22) Filed: Jan. 3, 2017

(51) Int. Cl. H04L 12/58; G06F 21/62

(52) U.S. Cl. CPC H04L 51/12; G06F 21/6245; H04L 51/08; H04L 51/34

(57) ABSTRACT

Techniques are disclosed relating to verifying electronic message integrity. In some embodiments, a computer system may store metadata for a first electronic message, including a first signature generated from the first electronic message. In some embodiments, the computer system may, in response to receiving a second electronic message indicated as being related to the first electronic message, compare the first signature to one or more signatures generated from the second electronic message. In some embodiments, the computer system may, based on the comparing, determine whether the second electronic message includes a modified version of content from the first electronic message.

### BACKGROUND

### Technical Field

This disclosure relates generally to electronic message systems, and more specifically to verifying the integrity of electronic messages.

### Description of the Related Art

Forwarding electronic messages is a common practice used to redistribute information. An originator of an electronic message may include sensitive information, such as personal or financial information, in an electronic message and send the electronic message to an initial recipient. The initial recipient may forward the electronic message to one or more forward recipients. In some instances, the initial recipient may modify the content of the electronic message before forwarding it to the one or more forward recipients. In various situations, it may be desirable to allow an originator of an electronic message to authorize modifications made to an original message.

### SUMMARY

Techniques are disclosed relating to verifying electronic message integrity. In some embodiments, a computer system may store metadata for a first electronic message subject to redistribution restrictions, including a first signature generated from the first electronic message. In some embodiments, the computer system may, in response to receiving a second electronic message indicated as being related to the first electronic message, compare the first signature to one or more signatures generated from the second electronic message. In some embodiments, the computer system may, based on the comparing, determine whether the second electronic message includes a modified version of content from the first electronic message. In some embodiments, the computer system may return a result indication based on the determination.

### BRIEF DESCRIPTION OF THE DRAWINGS

FIG. 1 is a block diagram illustrating an example electronic message verification system, according to some embodiments.

FIG. 2A is a block diagram illustrating an example configuration of a message server and a message verifier, according to some embodiments.

FIG. 2B is a block diagram illustrating an example configuration of a message server and a message verification server, according to some embodiments.

FIG. 3A is a block diagram illustrating an example message verification server, according to some embodiments.

FIG. 3B is a flow diagram illustrating an example method for verifying the integrity of an electronic message, according to some embodiments.

FIG. 4 is a block diagram illustrating an example electronic message verification system, according to some embodiments.

FIG. 5A is a flow diagram illustrating an example method for verifying the integrity of an electronic message, according to some embodiments.

FIG. 5B is a flow diagram illustrating an example method for implementing an electronic message integrity verification, according to some embodiments

FIGS. 6A-6G illustrate an example implementation of an electronic message verification process is shown, according to some embodiments.

FIG. 7 is a block diagram illustrating an example computer system that may be used to implement one or more of the components in an electronic message verification system, according to some embodiments.

### DETAILED DESCRIPTION

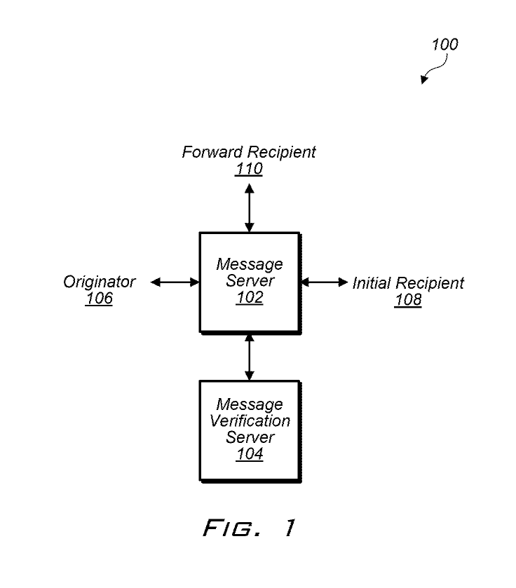

This disclosure describes, with reference to FIGS. 1-6, example systems and methods for verifying the integrity of an electronic message, according to various embodiments. Finally, an example computer system is described with reference to FIG. 7.

Referring now to FIG. 1, a block diagram illustrating an example system 100 for verifying the integrity of an electronic message is depicted. In the illustrated embodiment, system 100 includes a message server 102 and a message verification server 104. In various embodiments, system 100 may be usable by various entities, such as an originator 106 of an electronic message, an initial recipient 108 of the electronic message, and a forward recipient 110 of the electronic message. Note that, although shown in direct connection, one or more of message server 102, message verification server 104, originator 106, initial recipient 108, and/or forward recipient 110 may be connected via one or more communication networks (not shown for clarity).

In various embodiments, message server 102 may be configured to transfer electronic messages between various computer systems. In one embodiment, the electronic messages may include emails. This embodiment, however, is provided merely as an example and is not intended to limit the scope of the present disclosure. In other embodiments, for example, the electronic messages may include text messages, instant messages, personal messages, or any other electronic message. In transmitting an electronic message between computer systems, message server 102 may append various items of information to the electronic message, such as a header containing one or more fields. For example, message server 102 may append a header containing fields such as: From, To, CC, BCC, Subject, Date, or any other suitable fields. Additionally, message server 102 may assign a unique identifier, referred to herein as a “message identifier,” to an electronic message in order to uniquely identify it. In one embodiment, for example message server 102 may be implemented using a MICROSOFT EXCHANGE™ server and, in such embodiment, the message identifier may be referred to as a “Message-ID.” In some embodiments, a message identifier may consist of two portions, for example, a first portion and a second portion separated by an “@” symbol. In such embodiments, the first portion may include a unique identifier assigned by a message server, such as message server 402, to uniquely identify the electronic message. Further, in such embodiments, the second portion may include or otherwise reference the message server that assigned the message identifier.

In various embodiments, originator 106, initial recipient 108, and/or forward recipient 110 may send and/or receive electronic messages via message server 102. In such embodiments, these parties may use a computer system, such as a personal computer or mobile communication device, to send and/or receive electronic messages via the message server 102. For example, in some embodiments, the computer systems may include an electronic message application installed thereon. In such embodiments, the electronic message application may include a mail user agent (MUA), also referred to as an email client, configured to facilitate composing, sending, receiving, or otherwise accessing electronic messages. Further, in some embodiments, the computer system may include a web browser, which may be operable to access a web-based email client. In such embodiments, a user, such as originator 106, of the computer system may use the web-based email client accessed via the web browser to compose, send, receive, or otherwise access electronic messages.

In some embodiments, originator 106 may send an electronic message to initial recipient 108 via message server 102. After receiving the electronic message, initial recipient 108 may then forward the electronic message to one or more forward recipients, such as forward recipient 110. Further, in some embodiments, initial recipient 108 may add, remove, or otherwise modify content contained in the electronic message prior to sending the message to forward recipient 110. In some instances, this process can result in the efficient dissemination of information from the originator 106 to various parties. In some embodiments, however, originator 106 may want to verify that the initial recipient 108 has not modified the content of the electronic message before it is redistributed—that is, originator 106 may wish to verify the integrity of the electronic message before it is sent to forward recipient 110. For example, in one embodiment, the electronic message sent by originator 106 may contain one or more items of sensitive information, such as salary or other financial information. In this example, the initial recipient 108 may modify the content of the electronic message in an attempt to misrepresent the nature of the sensitive information to forward recipient 110. In another embodiment, initial recipient 108 may modify the content of an electronic message in an attempt to take credit for the work of originator 106. For example, in one embodiment, originator 106 and initial recipient 108 may be peers within an organization, both of whom are managed by forward recipient 110. In this example, originator 106 may send an electronic message containing sensitive information, such as an idea for a project, to initial recipient 108 for review. Initial recipient 108 may modify the content of the electronic message and send the modified version of the electronic message to forward recipient 110 in an attempt to take credit for the work of originator 106.

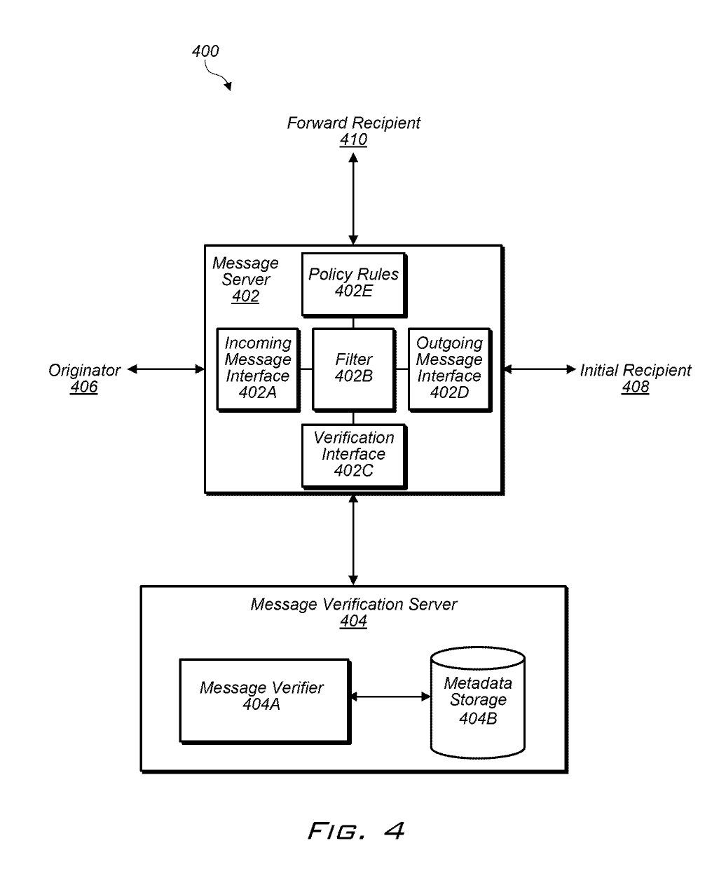

In various embodiments, message server 102 and/or message verification server 104 may implement one or more redistribution policies to verify the integrity of electronic messages. As used herein, the term “redistribution policies” may refer to restrictions on the sending (especially forwarding) of electronic messages with certain content. For example, in one embodiment, a redistribution policy implemented by message server 102 and/or message verification server 104 may restrict the forwarding of electronic messages that include information deemed to be sensitive information based on a set of rules. In various embodiments, originator 106 may send an electronic message, via message server 102, to initial recipient 108. Upon receipt of the electronic message, message server 102 may, as discussed in more detail below with reference to FIG. 4, determine that the electronic message is subject to redistribution restrictions. In response to this determination, message server 102 may send the electronic message, or a copy thereof, to message verification server 104. Message verification server 104 may then store metadata associated with the electronic message. For example, message verification server 104 may generate a message signature for the electronic message and store it, along with an associated message identifier, for use in later verification of the electronic message. Message server 102 may then facilitate the transfer of the electronic message to initial recipient 108.

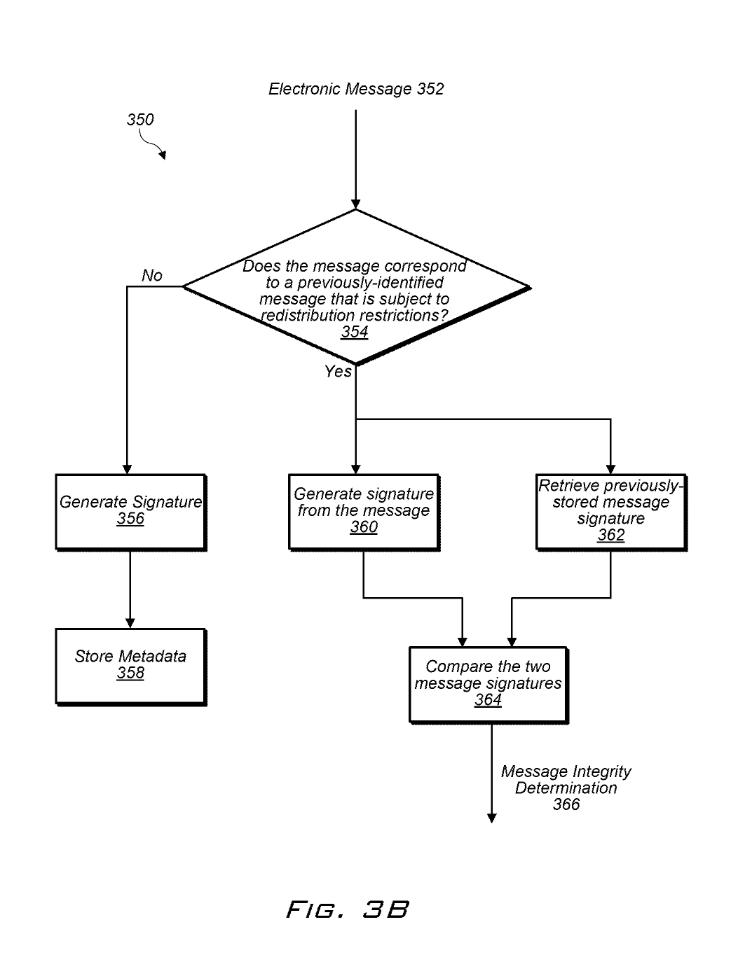

In some embodiments, initial recipient 108 may then attempt to forward the electronic message, via message server 102, to forward recipient 110. Upon receipt of the forwarded electronic message, message server 102 may determine that the forwarded electronic message is associated with an electronic message subject to redistribution restrictions. In response to this determination, message server 102 may send the forwarded electronic message, or a copy thereof, to message verification server 104. Message verification server 104 may then determine whether the forwarded electronic message includes a modified version of the content from the original electronic message. As discussed in more detail below with reference to FIG. 3, message verification server 104 may make this determination by comparing a stored message signature for an original version of the electronic message with a message signature for the forwarded electronic message.

Based on this determination, message verification server 104 may return a result indication. If the two message signatures do match (e.g., are the same), this may indicate that the forwarded electronic message does not include a modified version of content from the original electronic message and the result indication may specify that no redistribution policy has been violated. In some embodiments, the result indication may specify that the forwarded electronic message is to be delivered without restriction based on the determination indicating that no redistribution policy has been violated. If, however, the two message signatures do not match (e.g., are not the same), this may indicate that the forwarded electronic message does include a modified version of content from the original electronic message and the result indication may specify that at least one redistribution policy has been violated. In such embodiments, the result indication may specify that the forwarded electronic message is not to be delivered based on the determination indicating that at least one redistribution policy has been violated.

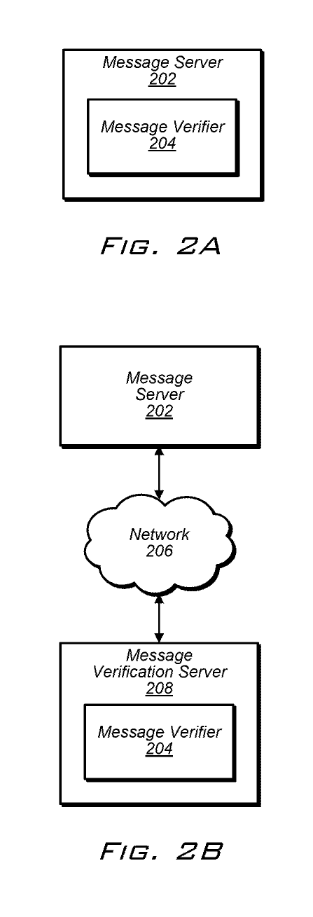

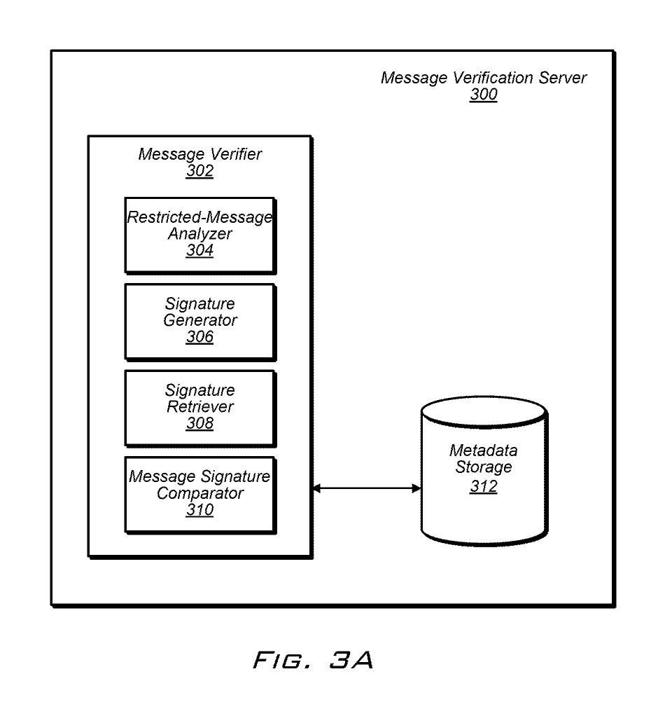

In some embodiments, in response to a determination that the forwarded electronic message includes a modified version of the original electronic message, message server 102 and/or message verification server 104 may take various actions, such as sending a notification to originator 106 indicating than an attempt has been made to send a modified version of the electronic message. In some embodiments, the notification may include a request for the originator 106 to authorize sending the modified version of the electronic message. Note that, although message server 102 and message verification server 104 are shown separately in FIG. 1, in various embodiments, message server 102 may be configured to perform some or all of the functionality of message verification server 104, as explained in more detail below with reference to FIGS. 2A and 2B.

Thus, in various embodiments, system 100 may allow a user, such as originator 106, to send electronic messages containing sensitive information to various parties while still allowing the originator 106 to review and authorize any changes made as the electronic message is redistributed. For example, in some embodiments, the initial recipient 108 may make modifications to the electronic message that the originator finds desirable, such as correcting a typographical error. In such embodiments, the originator 106 may wish to allow the electronic message, along with these modifications, to be forwarded to another party, such as forward recipient 110. In other embodiments, however, the initial recipient 108 may make modifications to the electronic message in order to misrepresent the content of originator 106's original electronic message. For example, consider the situation in which originator 106 and forward recipient 110 are both bidding to purchase a product sold by initial recipient 108. In this example, originator 106's original electronic message may include an offer price for the product. Initial recipient 108 may then attempt to modify the offer price included in the electronic message and forward the modified electronic message to forward recipient 110, in an effort to persuade forward recipient 110 to increase its own bid. In the event that initial recipient 108 is able to send this modified version of the electronic message, originator 106 may both lose out on the bid and assist initial recipient 108 in obtaining a higher purchase price. In various embodiments, however, system 100 may be configured to detect the modifications made to the electronic message and provide originator 106 with the opportunity to approve or deny the sending of the modified message.

Turning now to FIG. 2A, an example configuration of a message server 202, according to some embodiments, is shown. In the depicted embodiment, message server 202 includes message verifier 204. In such embodiments, message server 202 may be configured to perform some or all of the functionality of message verification server 104. In the embodiment of FIG. 2A, message server 202 may be configured to verify the integrity of an electronic message, for example sent from an initial recipient 108 to a forward recipient 110. For example, message server 202 may be configured to generate message signatures based on electronic messages, store metadata corresponding to the electronic messages, such as the message signature and associated message identifier(s), compare a generated message identifier with a stored message identifier to determine whether an electronic message includes a modified version of content, and/or return a result indication. The configuration of FIG. 2A may allow an entity, for example the entity using and/or operating message server 202, to perform message integrity verification using message server 202, without requiring that the electronic message be sent to a separate computer system to perform such actions.

In FIG. 2B, an example configuration of a message server 202 and a message verification server 208 is shown. In this depicted embodiment, message server 202 and message verification server 208 may be in communication via network 206. In such embodiments, message server 202 may receive a first electronic message, for example from originator 106 of FIG. 1, and determine that the first electronic message is subject to redistribution restrictions. Based on this determination, message server 202 may send the first electronic message, or a copy thereof, via network 206 to message verification server 208. Message verification server 208, using message verifier 204, may then generate a message signature for the first electronic message and store the message signature and corresponding message identifier for use in later message verification. Further, in such embodiments, message server 202 may receive a second electronic message, for example from initial recipient 108 to forward recipient 110 in FIG. 1, and determine that the second electronic message corresponds to an electronic message that is subject to redistribution restrictions. Based on this determination, message server 202 may send the second electronic message, or a copy thereof, to message verification server 208 via network 206. Message verification server 208, using message verifier 204, may then generate a message signature for the second message and compare this message signature with a stored message signature for the first electronic message to determine whether the second electronic message includes a modified version of content from the first electronic message. Message verifier 204 may then return a result indication based on this determination. The configuration of FIG. 2B may allow an entity, for example the entity using and/or operating message server 202, to provide message integrity verification to users of message server 202, while preserving resources for the other computing tasks performed by message server 202.

Referring now to FIG. 3A, a block diagram of a message verification server 300 is shown, according to some embodiments. Message verification server 300 may correspond to message verification server 104 in FIG. 1, in some embodiments. Message verification server 300 includes various modules, which may include program instructions embodied on a computer-readable medium, specifically-configured hardware, or a combination thereof. As shown in FIG. 3A, message verification server 300 may include message verifier 302 and metadata storage 312. In the illustrated embodiment, message verifier 302 may also include various modules, including restricted-message analyzer 304, signature generator 306, signature retriever 308, and message signature comparator 310. In some embodiments, message verifier 302 may correspond to message verifier 204 in FIGS. 2A and 2B.

As shown in FIG. 3A, message verifier 302 may include restricted-message analyzer 304. Restricted-message analyzer 304 may be configured to determine whether an electronic message corresponds to a previously-identified electronic message that is subject to redistribution restrictions. For example, in some embodiments, restricted-message analyzer 304 may compare one or more message identifiers to a set of identifiers corresponding to electronic messages previously indicated as having redistribution restrictions.

Further, message verifier 302 may include signature generator 306. In various embodiments, signature generator 306 may be configured to generate a message signature from one or more electronic messages. Signature generator 306 may generate the message signatures using various techniques. For example, in some embodiments, signature generator 306 may use a hash function, such as SHA-2, to generate message signatures based on the content of the electronic message. In such an embodiment, the message signatures may include a hash value. This described embodiment, however, is provided merely as an example and is not intended to limit the scope of the present disclosure. In other embodiments, for example, signature generator 306 may generate message signatures using a variety of techniques, such as checksums, check digits, fingerprinting algorithms, cryptographic hash functions, keyed hash functions, or by any other suitable technique.

In various embodiments, the message signatures generated by signature generator 306 may have various properties desirable for use in determining whether a second electronic message includes a modified version of content from a first electronic message. For example, in some embodiments, the process implemented by signature generator 306 to generate message signatures may be deterministic, such that, when given a particular input, such as a given electronic message, signature generator 306 will produce the same message signature as an output. This property may be desirable, for example, for determining that a forwarded message does not include a modified version of content from an original message. In such embodiments, for example, signature generator 306 will generate the same message signature for an unmodified, forwarded version of an electronic message as for the original electronic message. Message verifier 302 may then determine that the forwarded version of the electronic message has not been modified based on the two message signatures comparing equally.

Further, in various embodiments, signature generator 306 may generate message signatures utilizing a technique that produces a low likelihood of collisions, such that, when given two different inputs (e.g., an original electronic message and a modified electronic message), it will be unlikely that signature generator 306 generates two identical message signatures. This property may be desirable, for example, for determining that a forwarded message does include a modified version of content from an original message. In such embodiments, for example, signature generator 306 will generate a message signature for a modified message that is different from a message signature for the original message. Message verifier 302 may then determine that the forwarded message has been modified based on the two message signatures not matching (e.g., not being equal to one another).

In some embodiments, when a user, such as initial recipient 108 in FIG. 1, attempts to forward an electronic message using an email client, the email client may alter the formatting of the electronic message to indicate to the forward recipient that the electronic message is a forwarded version of an original electronic message. For example, in addition to the content from the original electronic message, the email client may include various items of identifying information, such as an indication of who the original electronic message was sent from, an indication of who the original electronic message was sent to, the subject line of the original electronic message, and/or the date and time the original electronic message was sent. Additionally, in some embodiments, the email client may add whitespace above and/or below the content of the original message to allow the initial recipient to provide a response or commentary to the original message. As noted above, however, modifications to the content of a message may result in changes in the resulting message signature. For example, modifications to the content of the electronic message, such as adding the identifying information or the initial recipient's commentary, may result in a different message signature for the forwarded message, even if the actual content of the original electronic message has not been modified. Thus, in some embodiments, signature generator 306 may be configured to differentiate between an original portion of the electronic message and one or more portions of the electronic message added by a party forwarding the electronic message and/or their email client, such as identifying information, commentary, whitespace, etc. For example, in one embodiment, signature generator 306 may be operable to add one or more delimiters to the original electronic message, for example as non-printable characters, to differentiate between the original portion of the electronic message and the one or more portions of the electronic message added by the forwarding party and/or their email client. In another embodiment, before generating a message signature for a message, signature generator 306 may be operable to remove whitespace and other text or formatting caused by a forwarding operation. Further, in some embodiments, message verification server 300 may be configured to store the original electronic message for use in future comparison between the original electronic message and a forwarded version of the electronic message.

Further, as shown in FIG. 3A, message verifier 302 may include signature retrieval 308. Signature retrieval 308 may be configured to identify and retrieve message signatures corresponding to a given electronic message that is subject to redistribution restrictions. In some embodiments, message verifier 302 may be configured to store metadata for a plurality of electronic messages that are identified as being subject to redistribution restrictions, for example using metadata storage 312. In some embodiments, the stored metadata may include a message identifier included in the electronic message and a message signature generated from the electronic message, for example by signature generator 306. In various embodiments, signature retriever 308 may be configured to retrieve metadata associated with a given electronic message based on a message identifier. For example, signature retriever 308 may compare one or more message identifiers included in an electronic message against the stored metadata. If it detects a match between the message identifiers, signature retriever 308 may be configured to retrieve the stored message signature associated with that message identifier.

Message verifier 302 may also include message signature comparator 310. In various embodiments, message signature comparator 310 may be configured to compare a message signature for a forwarded electronic message with the message signature for an original version of the electronic message. Message signature comparator 310 may make a message integrity determination based on the result of this comparison. Message verifier 302 may include this message integrity determination in a result indication, for example to message server 202 in FIGS. 2A and 2B.

Turning now to FIG. 3B, a flow diagram of method 350 is depicted. Method 350 is one embodiment of a method that may be performed, for example, by message verification server 300 of FIG. 3A. In various embodiments, method 350 (or either of methods 500 or 550) may facilitate message integrity verification of an electronic message.

In step 354, a message verification module, such as message verifier 302 of FIG. 3A, determines whether a received electronic message (e.g., electronic message 352) that is subject to redistribution restrictions corresponds to a previously-identified electronic message that is subject to redistribution restrictions. In some embodiments, step 354 may be performed, for example, by message identifier 302 of FIG. 3A.

If the received electronic message does not correspond to a previously-identified electronic message, method 350 proceeds to step 356. In various embodiments, if the received electronic message does not correspond to a previously-identified electronic message, this may indicate that the received electronic message is an original message. This received electronic message, sent, for example, from originator 106 to initial recipient 108 of FIG. 1, may further be subject to redistribution restrictions. In step 356, a message signature is generated for the received electronic message. In some embodiments, step 356 may be performed by signature generator 306 of FIG. 3A. For example, in one embodiment, signature generator 306 may utilize a hash function to create a message signature based on electronic message 352. In such an embodiment, the message signature may include a hash value of at least a portion of electronic message 352.

In step 358, metadata associated with electronic message 352 is stored. In some embodiments, message verification server 300 may be configured to store metadata for a plurality of electronic message that are identified as being subject to redistribution restrictions, for example, in metadata storage 312 of FIG. 3A. In some embodiments, the stored metadata may include one or more message identifiers included in electronic message 352 and the message signature generated from electronic message 352.

If, however, the received electronic message does correspond to a previously-identified electronic message, method 350 proceeds to steps 360-364. In various embodiments, if the received electronic message does correspond to a previously-identified electronic message, this may indicate that electronic message 352 is a forwarded version of an original electronic message that is subject to redistribution restrictions. In step 360, a message signature is generated for electronic message 352. In some embodiments, step 360 may be performed by signature generator 306 of FIG. 3A.

In step 362, a previously-generated message signature is retrieved, for example, by signature retriever 308 of FIG. 3A. In some embodiments, signature retriever 308 may perform step 362 by comparing one or more message identifiers included in electronic message 352 against the stored metadata for the plurality of electronic messages that are identified as being subject to redistribution restrictions. For example, in one embodiment, signature retriever 308 may compare a message identifier included in electronic message 352 against a table of message identifiers stored on metadata storage 312 that correspond to messages that are subject to redistribution restrictions. If signature retriever 308 detects a match between the message identifiers, it may be configured to retrieve the stored message signature associated with that message identifier.

In step 364, method 350 compares the message signature generated in step 360 against the previously-generated message signature retrieved in step 362. In one embodiment, for example, step 364 may compare a message signature generated in step 360 from a forwarded version of an original electronic message against a previously-generated message signature for the original message retrieved in step 362. In some embodiments, step 364 may be performed by message signature comparator 310 of FIG. 3A. In some embodiments message signature comparator 310 may make a message integrity determination, such as message integrity determination 366, based on the result of this comparison.

As noted above, if the message signature generated from the forwarded electronic message and the previously-generated message signature generated from the original electronic message do not compare equally, this may indicate that the forwarded electronic message includes a modified version of content from the original electronic message. In this embodiment, the message integrity determination 366 may indicate that at least one redistribution policy has been violated. If, however, the message signature generated from the forwarded electronic message and the previously-generated message signature generated from the original electronic message do match, this may indicate that the forwarded electronic message does not include a modified version of content from the original electronic message. In such an embodiment, the message integrity determination 366 may indicate that no redistribution policy has been violated. In various embodiments, message verifier 302 may include message integrity determination 366 in a result indication sent to a message server, such as message server 202 in FIGS. 2A and 2B.

Turning now to FIG. 4, a block diagram illustrating an example system 400 for verifying the integrity of an electronic message is depicted. As shown, system 400 includes message server 402 and message verification server 404. In various embodiments, system 400 may be usable by various entities, such as originator 406, initial recipient 408, and forward recipient 410.

In various embodiments, message server 402 and/or message verification server 404 may implement one or more redistribution policies to verify the integrity of electronic messages. For example, originator 406 may send an electronic message via message server 402 to initial recipient 408. In some embodiments, the electronic message may include information, such as personal or financial information, that is deemed to be sensitive information based on a set of rules.

Message server 402 may be configured to receive the electronic message, for example, via incoming message interface 402A. Upon receipt of the electronic message, message server 402 may determine, for example using filter 402B, that the electronic message is subject to redistribution restrictions. In some embodiments, filter 402B may include one or more software modules installed on message server 402 that are configured to detect electronic messages that are subject to redistribution restrictions. For example, in some embodiments, originator 406, prior to sending the electronic message, may provide a redistribution restriction indicator with the electronic message. In such embodiments, filter 402B may determine that the electronic message is subject to redistribution restrictions based on an identification of the redistribution restriction indicator provided by the originator 406. In some embodiments, however, instead of being based on an indicator provided by originator 406, filter 402B may determine that the electronic message is subject to redistribution restrictions based on detecting one or more items of information included in the electronic message. For example, in such embodiments, message server 402 may determine that the electronic message is subject to redistribution restrictions in response to parsing the electronic message to detect one or more items of information defined by a set of rules as sensitive information. In some embodiments, various users of message server 402, such as originator 406 and/or an administrator of message server 402, may establish the set of rules to dictate what information is classified as sensitive information. For example, in one embodiment, originator 406 may establish the set of rules to define personal information, such as a Social Security number, as sensitive information. In this described embodiment, filter 402B may parse the electronic message sent by originator 406 and, in response to detecting a numerical sequence in the format of a Social Security number, determine that the electronic message is subject to redistribution restrictions.

Further, in one embodiment, message server 402 may be configured to store various items of information associated with electronic messages that are subject to redistribution restrictions, such as a message identifier, a date and/or time of the electronic message, the sender of the electronic message, etc. In such an embodiment, message server 402 may be configured to compare information associated with an electronic message, such as one or more message identifiers, with the stored information associated with the electronic messages. Based on this comparison, message server 402 may be configured to determine whether an electronic message corresponds to a previously-identified electronic message that is subject to redistribution restrictions.

In some embodiments, one or more users of message server 402 and/or message verification server 404, such as originator 406, may define a list of authorized recipients. For example, in one particular embodiment, originator 406 may specify that a recipient, such as forward recipient 410, is included in a list of authorized recipients. In such an embodiment, message server 402 and or message verification server 404 may, in response to a determination that an electronic message corresponds to a previously-identified electronic message that is subject to redistribution restrictions, determine whether a forward recipient of the electronic message is included in a list of authorized recipients for the originator of that electronic message. For example, in this particular embodiment, message server 402 may determine whether forward recipient 410 is included in the list of authorized recipients for originator 406 and, in response to determining that forward recipient 410 is included in the list of authorized recipients, message server 402 may, in one embodiment, facilitate transfer of the electronic message to forward recipient 410 without further message integrity verification.

In response to a determination that the electronic message is or corresponds to an electronic message subject to redistribution restrictions, message server 402 may, in various embodiments, transfer the electronic message, or a copy thereof, via verification interface 402C to message verification server 404. Note that, in some embodiments, rather than sending the electronic message, message server 402 may send one or more items of metadata associated with the electronic message to message verification server 404.

In various embodiments, message verification server 404 includes message verifier 404A and metadata storage 404B. Message verifier 404A and metadata storage 404B may, in some embodiments, correspond to message verifier 302 and metadata storage 312, respectively, of FIG. 3.

Upon receiving the electronic message, message verification server 404 may determine whether the electronic message corresponds to a previously-identified electronic message that is subject to redistribution restrictions. In some embodiments, message verification server 404 may make this determination using restricted-message analyzer 304 of FIG. 3A. In one embodiment, for example, restricted-message analyzer 304 may compare one or more message identifiers included in the electronic message with stored metadata associated with a plurality of electronic messages that are subject to redistribution restrictions.

If restricted-message analyzer 304 does not detect a match between the message identifier(s) in the electronic message and the stored message identifiers, this may indicate that the electronic message is an original electronic message subject to redistribution restrictions. Message verification server 404 may then, as discussed more above with reference to steps 356-358 of FIG. 3B, store metadata associated with the electronic message for use in later verification of the integrity of the electronic message. For example, in some embodiments, message verification server 404 may generate a message signature for the electronic message and store it, along with one or more corresponding message identifiers, in metadata storage 404B.

In various embodiments, message verification server 404 may send to message server 402 a result indication. In an embodiment in which there is no match between message identifiers, the result indication may specify that the electronic message is to be delivered without restriction based on a determination that no redistribution policy has been violated. In such an embodiment, message server 402 may then facilitate transfer of the electronic message to the initial recipient 408 via outgoing message interface 402D.

However, if message verifier 404A does detect a match between the message identifier(s) in the electronic message and the stored message identifiers, this may indicate that the electronic message is a forwarded version of a previously-identified, original electronic message that is subject to redistribution restrictions. For example, initial recipient 408 may receive the original electronic message from originator 406 and attempt to send to forward recipient 410 a forwarded version of that original electronic message. In such embodiments, message verification server 404 may, as discussed previously with reference to steps 360-364 of FIG. 3B, verify the integrity of the forwarded version of the electronic message. For example, in various embodiments, message verifier 404A may generate, using signature generator 306 of FIG. 3A, a message signature from the forwarded version of the electronic message. Further, message verifier 404A may retrieve, via signature retriever 308 of FIG. 3A, a previously-generated message signature for the previously-identified electronic message that is subject to redistribution restrictions. Message verification server 404 may then compare the signatures to determine whether the forwarded version of the electronic message includes a modified version of content from the original electronic message. Message verification server 404 may return a result indication to message server 402 based on this determination.

In the event that the message signatures match, this may indicate that the forwarded version of the original electronic message is or includes an unmodified version of content from the original electronic message. For example, initial recipient 408 may have attempted to forward the original electronic message to forward recipient 410 without modifying the content of the original electronic message. In such embodiments, the result indication may specify that the forwarded version of the electronic message is to be delivered without restriction based on a determination that no redistribution policy has been violated. In the described embodiment, message server 402 may then facilitate transfer of the forwarded electronic message to the forward recipient 410 via outgoing message interface 402D.

If, however, the message signatures do not match, this may indicate that the forwarded version of the original electronic message does include a modified version of content from the original electronic message. For example, initial recipient 408 may have attempted to add, remove, or otherwise modify content contained in the original electronic message and send that modified version to forward recipient 410. In such embodiments, the result indication may specify that the forwarded version of the electronic message violates at least one redistribution policy.

As shown in FIG. 4, message server 402 may include message policy rules 402E. In various embodiments, message policy rules 402E may include definitions of one or more rules to implement in the event that a result indication specifies that one or more redistribution policies have been violated. Note that, although shown in message server 402, in some embodiments, message policy rules 402E may be included within message verification server 404, for example as part of message verifier 404A. In some embodiments, various users of message server 402, such as originator 406 and/or an administrator of message server 402, may define one or more rules included in message policy rules 402E. For example, originator 406 may define a policy rule specifying that, when a result indication is received that specifies that at least one redistribution policy has been violated, message server 402 is to not deliver the forwarded version of the electronic message to forward recipient 410. In such embodiments, message server 402 may drop or otherwise cause the forwarded version of the electronic message not to be delivered to forward recipient 410 and, in some embodiments, may send a notification of the event to originator 406, initial recipient 408, and/or forward recipient 410. Thus, in such embodiments, the one or more rules included in message policy rules 402E may automatically prevent the delivery of modified electronic messages, absent further intervention from, for example, originator 406.

Further, in some embodiments, a definition of a policy rule may specify that, when a result indication specifies that at least one redistribution policy has been violated, message server 402 and/or message verification server 404 is to send originator 406 a notification. In some embodiments, the notification may indicate that an attempt has been made to send a modified version of the original electronic message and may include a request the originator 406 to authorize sending the modified version of the original electronic message. Further, in some embodiments, the notification may include various items of information corresponding to the policy violation, such as an identity of the party attempting to forward the electronic message, an identity of the party to whom the electronic message is forwarded, the date and/or time of the attempted forward, the content of the forwarded electronic message, an identification of the modifications made to the original electronic message, etc. In such embodiments, originator 406 may respond to the alert notification, for example using an email client accessed via a computer system, such as a personal computer or mobile communication device.

If, in the described embodiment, the originator 406 sends a response denying the attempt to send the forwarded version of the electronic message, message server 402 may drop or otherwise cause the forwarded version of the electronic message not to be delivered. In some embodiments, message server 402 may additionally send a notification of the event to initial recipient 408 and/or forward recipient 410. If, however, in the described embodiment, the originator 406 sends a response authorizing the sending of the modified version of the original electronic message, message server 402 may facilitate transfer of the forwarded electronic message to the forward recipient 410 via outgoing message interface 402D. For example, in such embodiments, message server 402 and/or message verification server 404 may return a redistribution result permitting the forwarding of the modified version of the electronic message. In embodiments such as those depicted in FIG. 2B, message verification server 208 may receive the response from originator 406 authorizing the sending of the modified version of the message. In such embodiments, message verification server 208 may send a redistribution result to message server 202 configured to deliver the modified version of the electronic message.

In some embodiments, message server 402 and/or message verification server 404 may be configured to store multiple message signatures for a given electronic message. In some embodiments, originator 406 may approve of the modifications made to an electronic message by initial recipient 408 and authorize the modified electronic message to be sent to forward recipient 410. For example, in one embodiment, initial recipient 408 may have corrected a typographical error in the original electronic message and attempted to send the modified electronic message to forward recipient 410. In such embodiment, message verifier 404A may be configured to generate a second message signature corresponding to the modified version of the electronic message and store it, along with an associated message identifier, for use in later message integrity verification. This may facilitate further message integrity verification of the electronic message, for example, in the situation in which forward recipient 410 forwards the electronic message to another party. In some embodiments, storing a second message signature corresponding to the modified version of the electronic message may prevent the originator 406 from being required to authorize the forwarding of approved modifications to the electronic message.

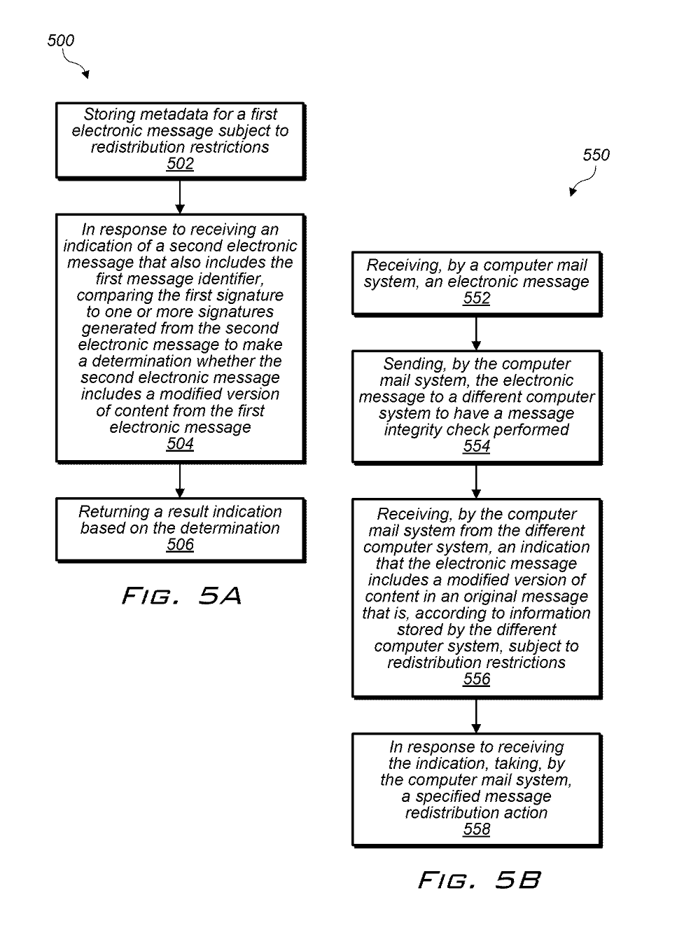

Referring now to FIG. 5A, a flow diagram is shown of an example method 500 for verifying the integrity of an electronic message, according to some embodiments. In various embodiments, method 500 may be implemented, for example, by message verification server 300 of FIG. 3. FIG. 5A comprises steps 502, 504, and 506. Step 502 includes storing metadata for a first electronic message subject to redistribution restrictions. For example, the stored metadata may include a first message identifier included in the first electronic message and a first signature generated from the first electronic message. In some embodiments, the metadata may be stored, for example, in metadata storage 312 of message verification server 300 in FIG. 3A.

Method 500 then proceeds to step 504, which includes, in response to receiving an indication of a second electronic message that also includes the first message identifier, comparing the first signature to one or more signatures generated from the second electronic message to make a determination whether the second electronic message includes a modified version of content from the first electronic message. In some embodiments, signature retriever 308 may retrieve the first signature generated from the first electronic message. Further, in some embodiments, signature generator 306 may generate one or more signatures from the second electronic message. In various embodiments, message signature comparator may then compare the first signature to the one or more signatures generated from the second electronic message to make a message integrity determination.

Method 500 then proceeds to step 506, which includes returning a result indication based on the determination. If the message signatures do not match, the result indication, such as message integrity determination 366 of FIG. 3B, may specify that at least one redistribution policy has been violated. If, however, the message signatures do match, the result indication may specify that no redistribution policies have been violated.

Referring now to FIG. 5B, a flow diagram is shown of an example method 550 for implementing an electronic message integrity verification is shown, according to some embodiments. In various embodiments, method 550 may be implemented, for example, by message server 402 of FIG. 4. FIG. 5B comprises steps 552, 554, 556, and 558. Step 552 includes receiving, by a computer mail system, an electronic message. For example, in one embodiment, message server may receive the electronic message, via incoming message interface 402A, from originator 406.

Method 550 then proceeds to step 554, which includes sending, by the computer mail system, the electronic message to a different computer system to have a message integrity check performed. In some embodiments, the computer mail system may send the electronic message to the different computer system in response to a determination that the electronic message is subject to redistribution restrictions. For example, in one embodiment, filter 402B may determine that the electronic message is subject to redistribution restrictions in response to parsing the electronic message to detect one or more items of information defined by a set of rules as sensitive information.

Method 550 then proceeds to step 556, which includes receiving, by the computer mail system from the different computer system, an indication that the electronic message includes a modified version of content in an original message that is, according to information stored by the different computer system, subject to redistribution restrictions. For example, in one embodiment, message verification server 404 may determine that a message signature for the electronic message does not match a previously-generated message signature for an original version of the electronic message. In such an embodiment, message verification server 404 may send a result indication to message server 402 that specifies that the electronic message violates at least one redistribution policy.

Method 550 then proceeds to step 558, which includes, in response to receiving the indication, taking, by the computer mail system, a specified message redistribution action. For example, in one embodiment, the specified message redistribution action may include sending, by message server 402, a notification to originator 406 that indicates that an attempt has been made to send a modified version of an electronic message sent by originator 406.

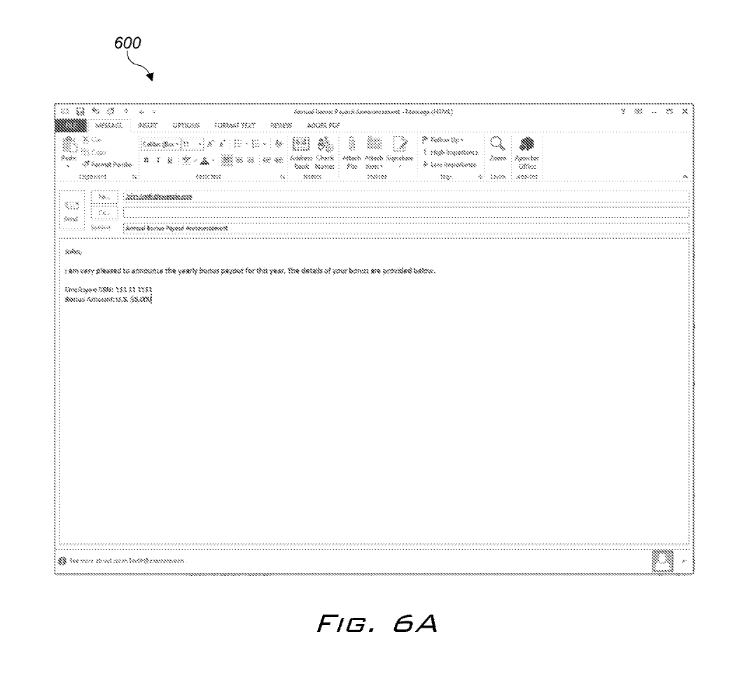

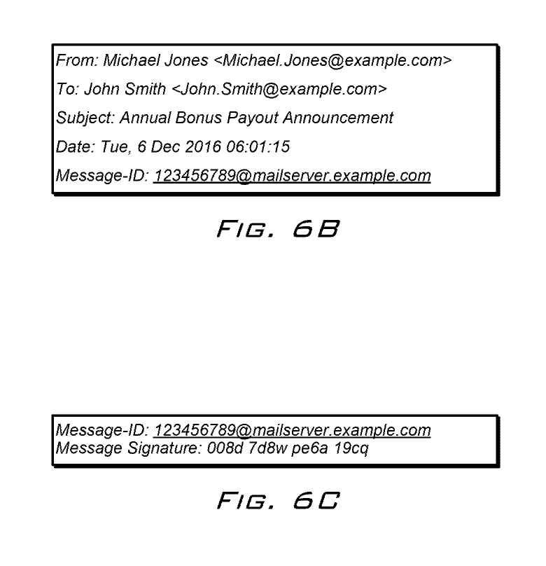

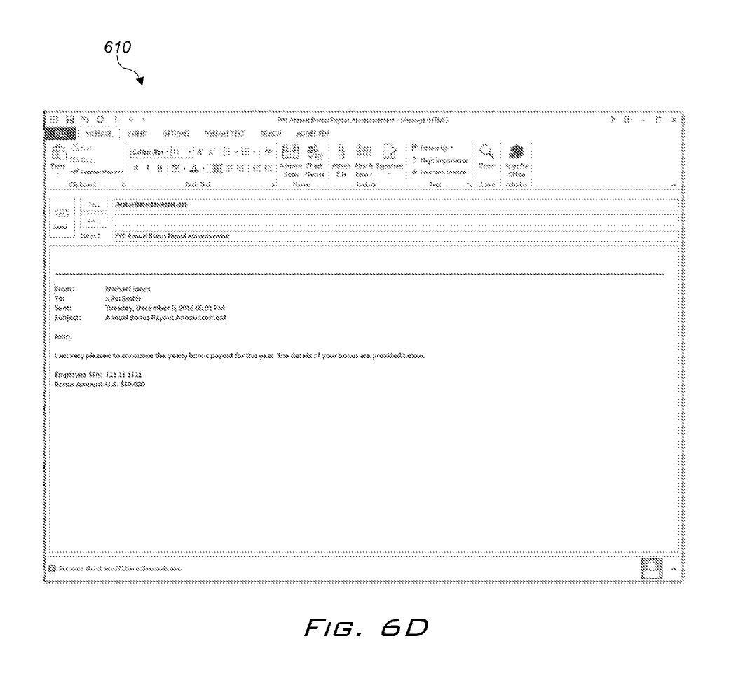

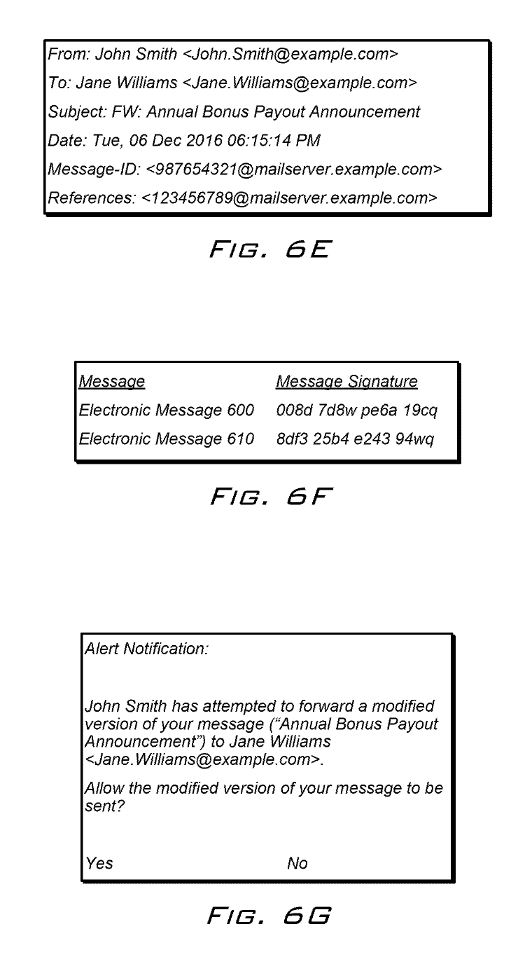

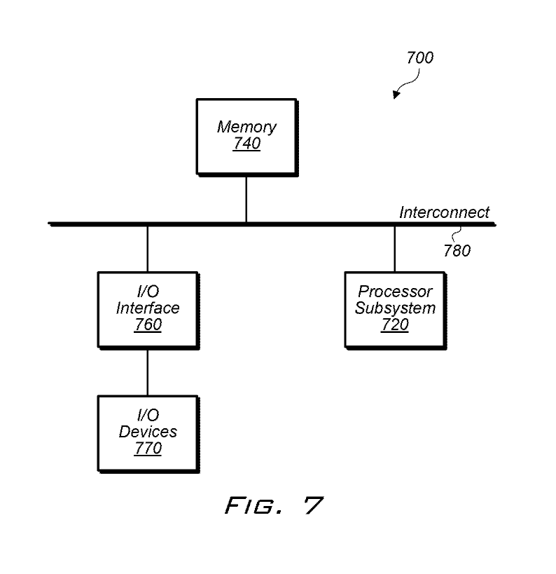

Turning now to FIGS. 6A-6G, an example implementation of the described electronic message verification process is shown.

In FIG. 6A, an example electronic message 600 is shown. In the depicted embodiment, electronic message 600 may correspond to an electronic message sent by originator 406, via message server 402, to initial recipient 408 in FIG. 4. For example, the electronic message of FIG. 6A may be an original electronic message that contains sensitive information, including personal and financial information such as a Social Security number or an employee's bonus payout amount.

In the depicted embodiment, a message server, such as message server 402, may be configured to receive electronic message 600. In various embodiments, message server 402 may be configured to append various items of information to electronic message 600, such as a header containing one or more fields. In FIG. 6B, a portion of a header appended to electronic message 600 is shown. As shown in FIG. 6B, the header includes fields for various items of information, including: who the electronic message was sent from, who the electronic message was sent to, the subject of the electronic message, the date and time the electronic message was sent, and a message identifier corresponding to electronic message 600.

Upon receipt, message server 402 may determine whether electronic message 600 is subject to redistribution restrictions. In one embodiment, the originator of electronic message 600 may, prior to sending the electronic message, set a redistribution restriction indicator to indicate that electronic message 600 is subject to redistribution restrictions. In such an embodiment, message server 402 may be configured to detect the redistribution restriction indicator provided by the originator. In another embodiment, message server 402 may be configured to determine that electronic message 600 is subject to redistribution restrictions by parsing the electronic message to detect one or more items of information defined by a set of rules as sensitive information. For example, in the depicted embodiment, message server 402 may include, for example in filter 402B, a rule that defines Social Security numbers as an item of sensitive information. In such an embodiment, message server 402 may be configured to parse electronic message 600 and determine that it is subject to redistribution restrictions based on detecting the Social Security number included therein.

In response to a determination that electronic message 600 is subject to redistribution restrictions, message server 402 may transfer the electronic message to a message verification server, such as message verification server 404 of FIG. 4. Note, however, that in some embodiments, the message server may include a message verification module, such as the configuration depicted by message server 202 and message verifier 204 in FIG. 2A. Upon receiving electronic message 600, message verification server 404 may determine whether the electronic message corresponds to a previously-identified electronic message that is subject to redistribution restrictions. For example, in the depicted embodiment, message verification server 404 may compare the message identifier for electronic message 600, “123456789@mailserver.example.com” in the depicted embodiment, with a table of message identifiers associated with electronic messages that are subject to redistribution restrictions. Since, in the depicted embodiment, electronic message 600 is an original electronic message and not a forwarded version of an electronic message, message verification server 404 may detect no match between the message identifier corresponding to electronic message 600 and the table of message identifiers. As discussed above with reference to steps 356-358 of FIG. 3B, message verification server 404 may then store metadata associated with electronic message 600. For example, as depicted in FIG. 6C, message verification server 404 may generate a message signature for electronic message 600 and store it, along with the message identifier, for use in later integrity verification.

Message verification server 404 may send to message server 402 a result indication specifying that electronic message 600 is to be delivered without restriction. Message server 402 may facilitate transfer of electronic message 600 to an initial recipient, such as initial recipient 408.

In FIG. 6D, an example electronic message 610 is shown. In the depicted embodiment, initial recipient 408 may receive electronic message 600 and attempt to send a modified version of electronic message 600, such as electronic message 610, to a forward recipient 410 via message server 402. As shown in FIG. 6D, initial recipient 408 may modify various items of information contained in the electronic message 600, such as the bonus amount, prior to attempting to forward electronic message 610 to forward recipient 410. Further, initial recipient 408 may have attempted to send electronic message 610 using an email client, which, as shown in FIG. 6D, may have altered the formatting of electronic message 600 in generating electronic message 610. For example, in the depicted embodiment, the email client added various items of identifying information to the electronic message, including: an indication of who the original electronic message was sent from, an indication of who the original electronic message was sent to, a date and time the original electronic message was sent, and a subject line for the original electronic message. Additionally, the email client added whitespace above the appended identifying information to allow initial recipient 408 to provide a response or commentary.

Upon receipt, message server 402 may determine whether electronic message 610 is subject to redistribution restrictions. In one embodiment, message server 402 may be configured to detect a redistribution restriction indicator originally provided by originator 406. In another embodiment, message server 402 may be configured to determine that electronic message 610 is subject to redistribution restrictions by parsing the electronic message to detect one or more items of information, such as a Social Security Number, defined by a set of rules as sensitive information.

As discussed above, message server 402 may be configured to append various items of information to electronic messages, such as a header including a field for a message identifier. In various embodiments, message server 402 may append the items of information to the electronic message without removing one or more items of information that were previously-appended to the electronic message. For example, FIG. 6B depicts a portion of the header appended to electronic message 600 by message server 402 to facilitate delivery to initial recipient 408. In FIG. 6E, a portion of the header appended to electronic message 610 by message server 402 is depicted. As shown in the depicted embodiment, the header in FIG. 6E may incorporate portions of information previously appended to an electronic message in a header for a forwarded version of the electronic message. For example, as shown in FIG. 6E, the header appended to electronic message 610 may include two message identifiers, one particular to electronic message 610 (e.g., 987654321@mailserver.example.com), and one referring to a previous message identifier assigned to electronic message 600 (e.g., 123456789@mailserver.example.com).

In one embodiment, as noted above, message server 402 may store information associated with electronic messages subject to redistribution restrictions, such as a message identifier. In such an embodiment, message server 402 may be configured to compare information associated with electronic message 610, such as one or more message identifiers, with stored information associated with electronic messages subject to redistribution restrictions. In the depicted embodiment, message server 402 may determine that one of the message identifiers included in electronic message 610 (123456789@mailserver.example.com) matches a stored message identifier associated with electronic message 600. Based on this determination, message server 402 may determine that electronic message 610 corresponds to electronic message 600, which was previously identified as being subject to redistribution restrictions, and send electronic message 610 to message verification server 404.

Upon receiving electronic message 610, message verification server 404 may, as discussed more above with reference to steps 360-364 of FIG. 3B, verify the integrity of electronic message 610. For example, message verification server 404 may generate, e.g., using signature generator 306 of FIG. 3A, a message signature for electronic message 610. Further, message verification server 404 may retrieve, e.g., using signature retriever 308 of FIG. 3A, a previously-generated message signature for electronic message 600. In FIG. 6F, a table is depicted showing the message signatures for electronic messages 600 and 610. Message verification server 404 may then compare the signatures to determine whether electronic message 610 includes a modified version of content from electronic message 600. In the depicted embodiment, initial recipient 408 modified the content of the original electronic message 600 by changing the bonus amount. Accordingly, when the message verification server 404 generated the message signature for electronic message 610, it did not result in the same message signature as for electronic message 600. Thus, in the depicted embodiment, the message signatures for electronic messages 600 and 610 do not compare equally. Message verification server 404 may then transmit a result indication to message server 402 specifying that electronic message 610 violates at least one redistribution policy.

In response to the result indication, message server 402 may implement one or more policy rules. For example, in the depicted embodiment, a definition of a policy rule may specify that message server 402 is to send originator 406 a notification in response to at least one redistribution policy being violated. In FIG. 6G, an example notification is depicted. In this embodiment, the notification indicates that an attempt has been made to send a modified version of electronic message 600. Further, the notification specifies the party that attempted to send the modified version and who they attempted to send it to. Further, in the depicted embodiment, the notification includes a request to authorize sending electronic message 610. Originator 406 may then authorize sending electronic message 610, in which case message server 402 will facilitate transfer of the electronic message to forward recipient 410. Alternatively, originator 406 may deny sending the electronic message, in which case message server 402 may drop or otherwise cause electronic message 610 not to be delivered to forward recipient 410.

In various embodiments, the disclosed systems and methods facilitate various improvements to the functionality of electronic messaging systems, such as improving the security and integrity of electronic messages as they are transferred through the system. For example, in various embodiments, the disclosed systems and methods may allow a user to send electronic messages containing sensitive information to various parties, while still allowing the user to review and authorize any changes made as the electronic message is redistributed. Thus, the disclosed systems and methods improve the functioning of the electronic messaging system, at least, by identifying and preventing unauthorized redistribution of electronic messages.

### Example Computer System

Turning now to FIG. 7, a block diagram of an exemplary computer system 700, which may implement one or more computer systems, such as message server 402 and/or message verification server 404, is depicted. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 700 is shown in FIG. 7 for convenience, system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as memory 740. Rather, computer system 700 may also include other forms of storage such as cache memory in processor subsystem 720 and secondary storage on I/O Devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 770 (e.g., configured to communicate over WiFi, Bluetooth, Ethernet, etc.).

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to generate a transaction token” is intended to cover, for example, a device that performs this function during operation, even if the device in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile device, for example, would not be considered to be “configured to” perform some specific function, although it may be “configurable to” perform that function. After appropriate programming, the mobile device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory, computer-readable medium having instructions stored thereon that are executable by a computing system to perform operations comprising:
storing metadata for a first electronic message subject to redistribution restrictions, wherein the stored metadata includes:
a first message identifier included in the first electronic message; and
a first signature generated from the first electronic message;
in response to receiving an indication of a second electronic message that also includes the first message identifier, comparing the first signature to one or more signatures generated from the second electronic message to make a determination whether the second electronic message includes a modified version of content from the first electronic message; and
returning a result indication based on the determination.

2. The non-transitory, computer-readable medium of claim 1, wherein the result indication specifies that the second electronic message is to be delivered without restriction based on the determination indicating that no redistribution policy has been violated.

3. The non-transitory, computer-readable medium of claim 1, wherein the result indication specifies that the second electronic message is not to be delivered based on the determination indicating that at least one redistribution policy has been violated.

4. The non-transitory, computer-readable medium of claim 1, wherein the operations further comprise:
sending, to an originator of the first electronic message, a notification indicating that an attempt has been made to send a modified version of the first electronic message, wherein the notification includes a request for the originator to authorize sending of the modified version of the first electronic message.

5. The non-transitory, computer-readable medium of claim 4, wherein the operations further comprise:
receiving, from the originator, a response authorizing the sending of the modified version of the first electronic message; and
returning a redistribution result permitting forwarding of the modified version of the first electronic message.

6. The non-transitory, computer-readable medium of claim 1, wherein the operations further comprise:
sending the result indication to a mail server configured to deliver the second electronic message.

7. The non-transitory, computer-readable medium of claim 1, wherein the operations further comprise:
determining that the second electronic message corresponds to a message with redistribution restrictions by comparing one or more message identifiers included in the second electronic message with a plurality of stored message identifiers corresponding to a plurality of messages with redistribution restrictions.

8. The non-transitory, computer-readable medium of claim 1, wherein the operations further comprise:
determining that the first electronic message is subject to redistribution restrictions based on identification of a redistribution restriction indicator provided by an originator of the first electronic message.

9. The non-transitory, computer-readable medium of claim 1, wherein the operations further comprise:
determining that the first electronic message is subject to redistribution restrictions in response to parsing the first electronic message to detect one or more items of information defined by a set of rules as sensitive information.

10. The non-transitory, computer-readable medium of claim 1, wherein the first signature generated from the first electronic message includes a hash value of the at least a portion of the first electronic message.

11. A method, comprising:
storing, by a computer system, metadata for a first electronic message, wherein the metadata includes a first signature generated from the first electronic message;
in response to receiving a second electronic message indicated as being related to the first electronic message, comparing, by the computer system, the first signature to one or more signatures generated from the second electronic message;
based on the comparing, the computer system determining whether the second electronic message includes a modified version of content from the first electronic message; and
returning, by the computer system, a result indication based on the determination.

12. The method of claim 11, further comprising:
sending, by the computer system to an originator of the first electronic message, a request to authorize sending of the second electronic message, wherein the request indicates that an attempt has been made to forward a modified version of the first electronic message.

13. The method of claim 12, further comprising:
receiving, by the computer system from the originator, a response authorizing the sending of the modified version of the first electronic message; and
returning, by the computer system, a redistribution result permitting forwarding of the modified version of the first electronic message.

14. The method of claim 13, further comprising:
sending, by the computer system, the redistribution result to a mail server configured to deliver the second electronic message.

15. The method of claim 11, wherein the result indication specifies that the second electronic message is not to be delivered based on the determination indicating that at least one redistribution policy has been violated.

16. The method of claim 11, further comprising:
determining, by the computer system, whether a forward recipient is included in a list of authorized recipients for an originator of the first electronic message; and
in response to determining that the forward recipient is included in the list of authorized recipients, sending, by the computer system, the second electronic message to the forward recipient.

17. A method, comprising:
receiving, by a computer mail system, an electronic message;
sending, by the computer mail system, the electronic message to a different computer system to have a message integrity check performed;
receiving, by the computer mail system from the different computer system, an indication that the electronic message includes a modified version of content in an original message that is, according to information stored by the different computer system, subject to redistribution restrictions; and
in response to receiving the indication, taking, by the computer mail system, a specified message redistribution action.

18. The method of claim 17, wherein the specified message redistribution action includes sending, by the computer mail system to an originator of the original message, a notification indicating that an attempt has been made to send a modified version of content of the original message, wherein the notification includes a request to authorize sending the modified version of content in the original message.

19. The method of claim 18, wherein the sending is performed in response to determining that the electronic message is subject to redistribution restrictions.

20. The method of claim 19, wherein the determining that the electronic message includes redistribution restrictions includes:
parsing, by the computer mail system, the electronic message to detect one or more message identifiers generated by a computer mail server; and
comparing, by the computer mail system, the one or more message identifiers to a set of message identifiers corresponding to electronic messages previously indicated as having redistribution restrictions.
